(19) United States
(12) Patent Application Publication
(10) Pub. No.: US 2004/0004098 A1
(43) Pub. Date: Jan. 8, 2004

(54) Fastening device for mounting a basket or a child seat

(76) Inventor: Georg Grimstad, Ulsteinvik (NO)

Correspondence Address: MAINE & ASMUS, 100 MAIN STREET, P O BOX 3445, NASHUA, NH, 03061-3445, US

(21) Appl. No.: 10/398,337

(22) PCT Filed: Dec. 7, 2000
(86) PCT No.: PCT/NO00/00419

(30) Foreign Application Priority Data
Aug. 8, 2000 (NO) 20004000

(51) Int. Cl. B60R 7/00; B60R 9/00

(52) U.S. Cl. 224/409; 224/411

(57) ABSTRACT

A fastening device for detachable mounting of a shopping basket or a child seat on the handle (5) of a pram or a shopper's trolley is described. The fastening device includes a cross rail (3) being placed across two mainly parallel parts of the handle and furthermore comprises a hook shaped organ (2) for mounting around the part of the handle (5) connecting the mainly parallel parts. The shopping basket's (4) or child seat's angle in proportion to the handle (5) is regulated by means of a regulating mechanism (6).

The present invention regards a fastening device for detachable attachment of a shopping basket, child's seat or similar to a shopping trolley, pram or similar.

When a person with a child in a pram comes to shop in a shop, he or she finds it difficult to handle both the pram and the shopping trolley at the same time. A number of shops therefore now provide shopping trolleys on which are mounted a child's seat, so as to allow the child to be placed in the child's seat for the duration of the shopping. This solution entails the child having to be removed from the pram and placed in the seat, while the pram must be left in a part of the shop that is not normally supervised. The solution also means that the shop must have a number of shopping trolleys with children's seats available at all times.

From Norwegian patent application no. 1999 4711 there is known a shopping trolley for use in combination with a pram, which shopping trolley has an underframe provided with devices designed to support the rear pair of wheels on the pram. The disadvantage of this solution however, is that it is the rear part of the pram that turns, making it difficult for the person pushing the shopping trolley with the attached pram to turn. Another disadvantage of this solution is that the actual shopping trolley has relatively large dimensions and a small loading volume. When the basket of the shopping trolley has been filled with goods, the person pushing the pram will also have difficulties seeing the child.

An object of the present invention is therefore to provide a fastening device of the type mentioned introductorily, for attaching a shopping basket or similar to a pram or similar.

Another object is to provide a fastening device of the type mentioned introductorily, with a shopping basket on the handle of a pram, in a maimer such that the weight of the shopping basket and the weight of the items in the shopping basket do not cause the pram to rear up.

Yet another object of the present invention is to provide a fastening device of the type mentioned introductorily, equipped with a child's seat in a manner so as to allow the fastening device and the child's seat to be attached to an arbitrary shopping trolley.

These and other objects that will appear in the following detailed description of preferred embodiments, are achieved by a fastening device for detachable mounting of a shopping basket or a child's seat on a pram or a shopping trolley, characterised in that the fastening device includes a crossbar for placement across the generally parallel parts of a handle on a pram or a shopping trolley, along with a hook-shaped organ connected to the crossbar for placement across that part of the handle that connects the generally parallel parts of the handle.

Preferably, the device includes regulating means for regulating the angle of the shopping basket or the child's seat relative to the fastening device

One end of the regulating means is provided with a handle or a lever, and the other end is provided with a catch lever that engages a complementary shaped toothed means on the underside of the shopping basket or child's seat, the shopping basket or child's seat preferably being rotatably connected to the fastening device by means of a hinge or an axle, and the regulating means preferably being spring loaded into engagement with the toothed means.

Preferably, the shopping basket has a generally guttiform cross section.

In the following, the invention will be explained in greater detail through the use of examples of embodiments, with reference to the accompanying drawings.

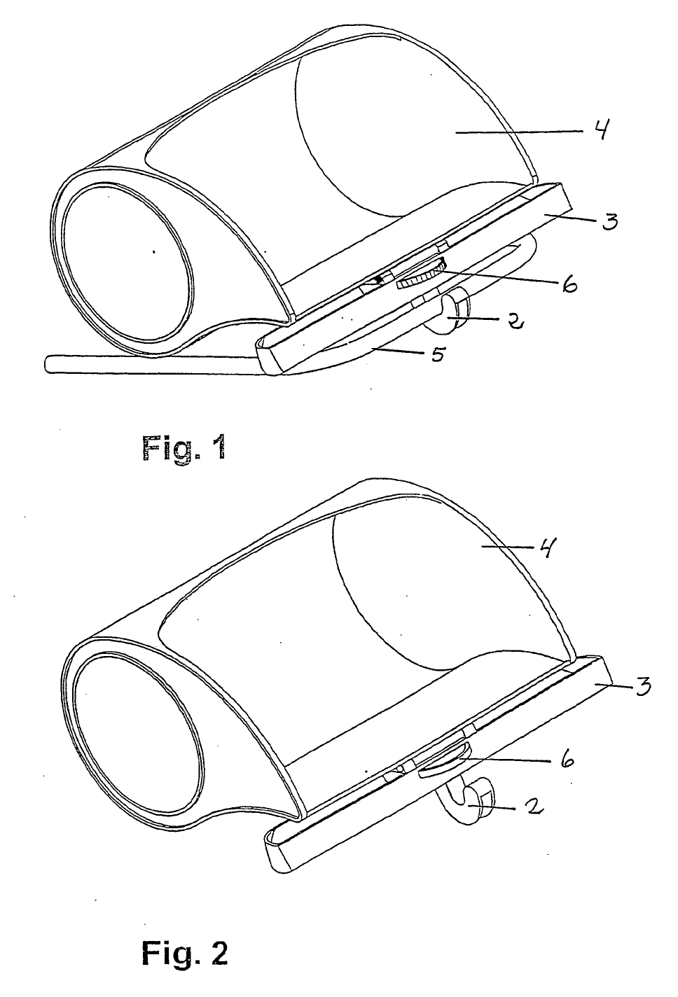

FIG. 1 is a perspective view of an embodiment of a fastening device in accordance with the invention, connected to a shopping basket mounted on the handle of a pram or similar;

FIG. 2 is a perspective view of the fastening device of FIG. 1 when it is not mounted on a handle;

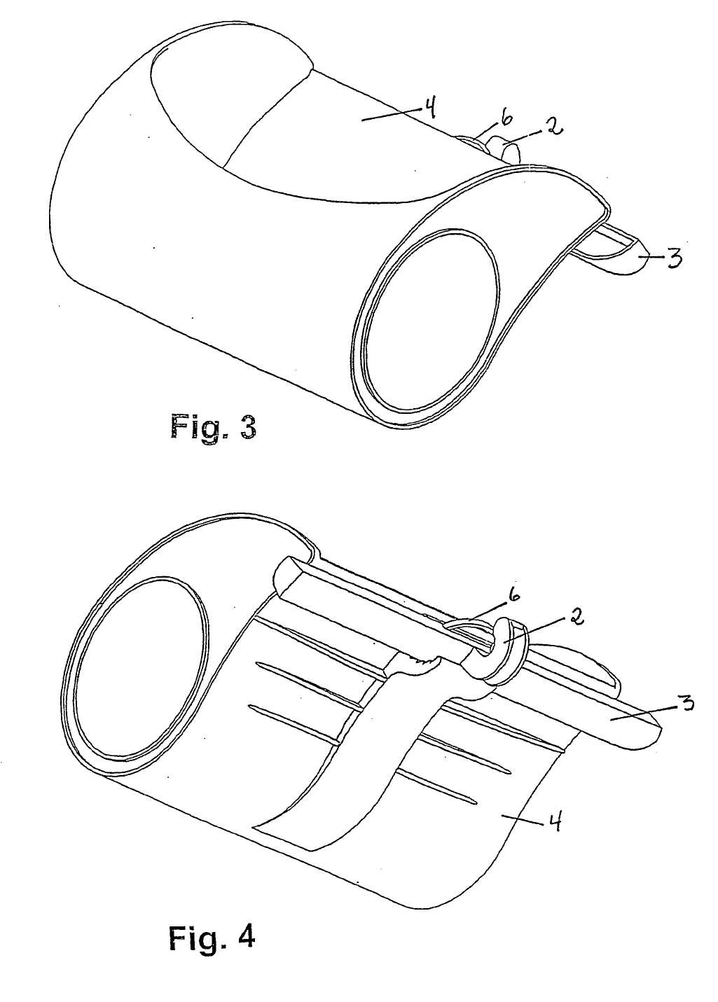

FIG. 3 is a perspective view of the fastening device of FIG. 1, seen from above;

FIG. 4 is a perspective view of the fastening device of FIGS. 1-3, seen from below;

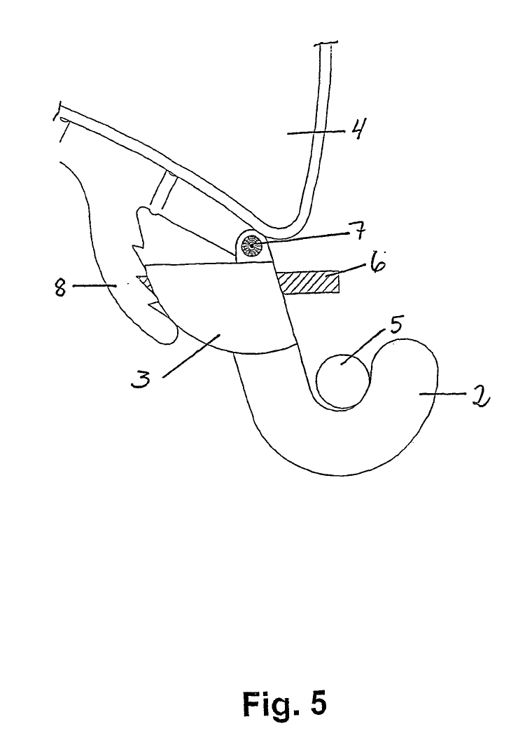

FIG. 5 shows a detail of the fastening device in accordance with FIGS. 1-4;

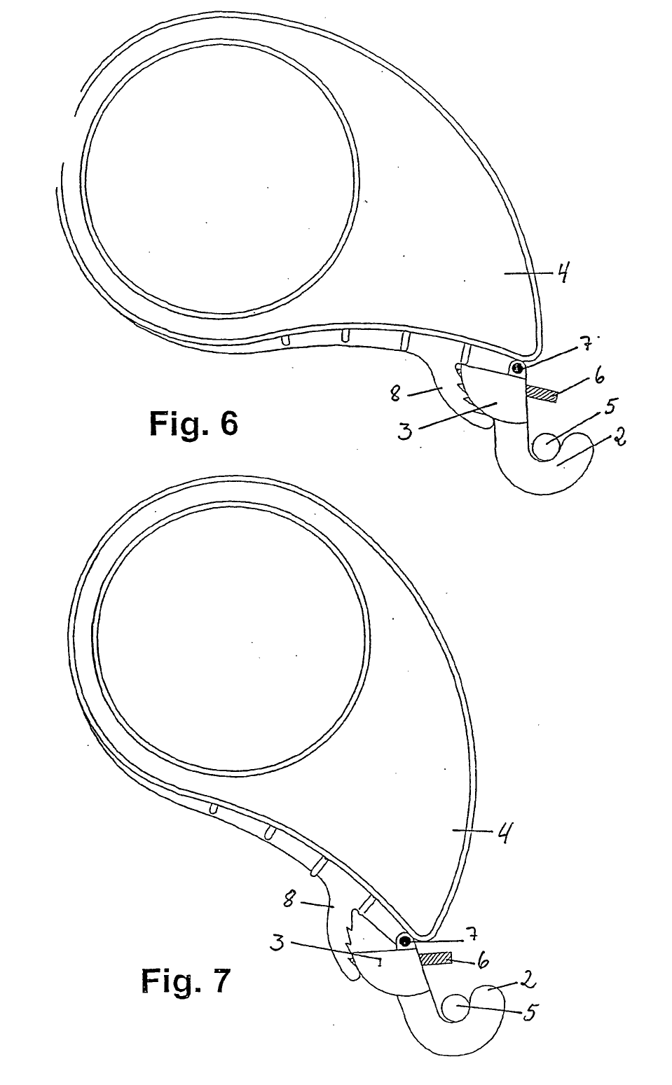

FIG. 6 shows an embodiment of a regulating mechanism of the fastening device of FIGS. 1-5, in a first position.

FIG. 7 shows the regulating mechanism of FIG. 6 in a second position;

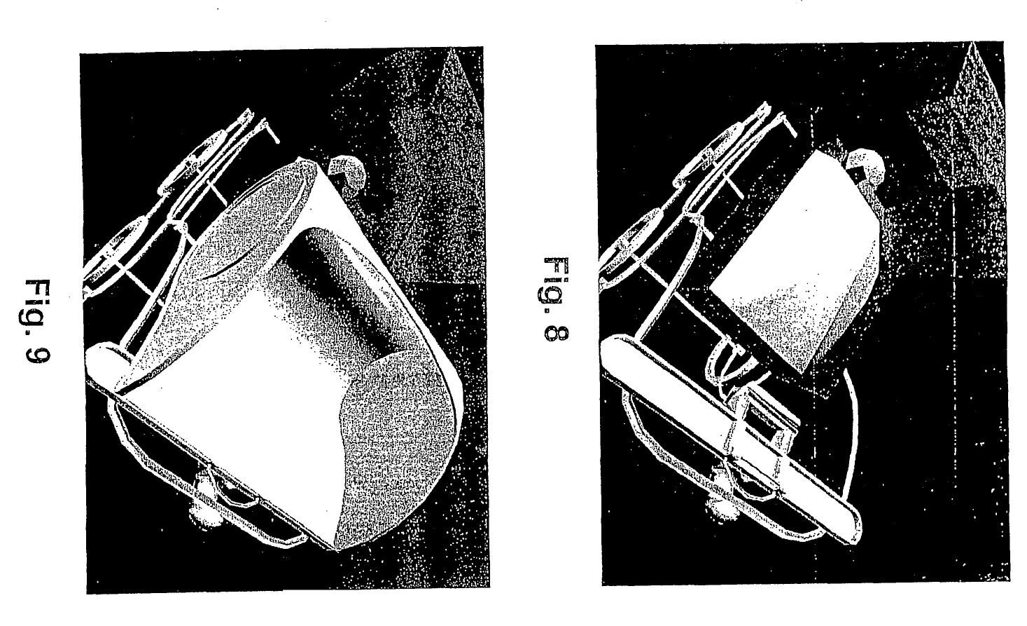

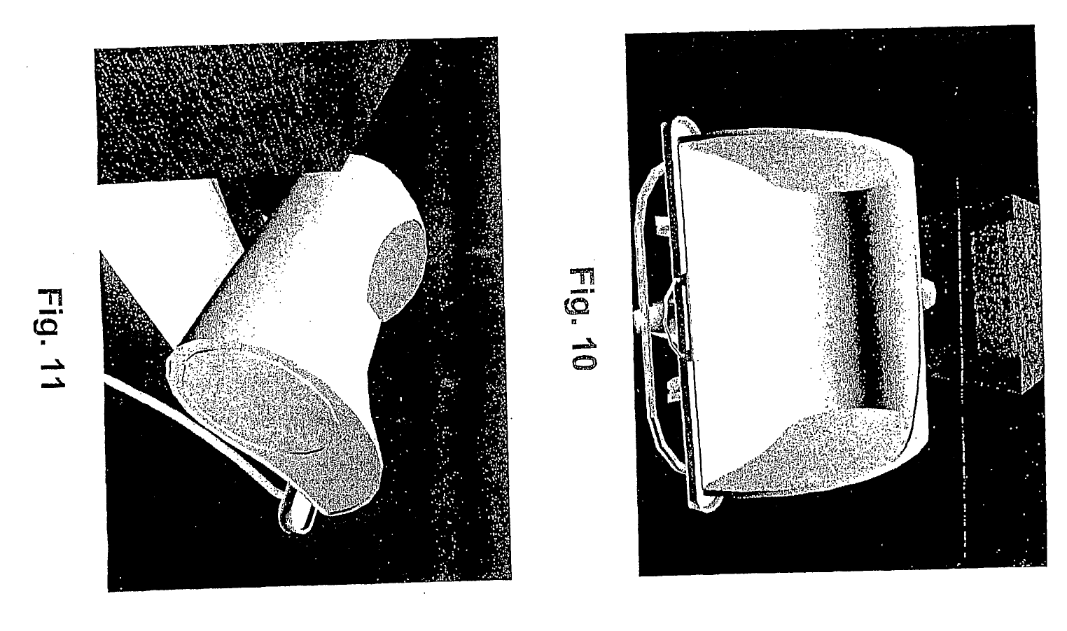

FIGS. 8 to 11 shows the fastening device and the shopping basket of FIGS. 1 and 7, seen from various directions.

In the following, the invention will be explained in greater detail through the use of an example of an embodiment, in which the fastening device in accordance with the invention is attached to the handle of a pram. It should however be noted that the fastening device may similarly be used for detachable mounting of e.g. a child's seat to a shopping trolley.

FIGS. 1 to 4 show an embodiment of the fastening device in accordance with the present invention, to which is attached a shopping basket or similar. In the embodiment shown, the fastening device consists of one or more hook-shaped organ 2, a crossbar 3, a shopping basket 4 and a regulating mechanism 6 for adjusting the angle of the shopping basket 4 relative to the fastening device. In FIG. 1, the fastening device and shopping basket are shown attached to a handle 5, e.g. of a pram or similar. The device is attached to the handle 5 in a manner that leaves the crossbar 3 lying across each of the two approximately parallel parts of the handle 5, while the hook-shaped organ 2 is arranged partially around that part of the handle 5 which connects the two approximately parallel parts of the handle 5. The weight of the shopping basket 4 will create a momentum so as to force the crossbar 3 down towards the handle 5, at the same time as the hook-shaped organ 2 is forced upwards towards the handle 5.

FIG. 5 shows a detail of a regulating mechanism 6 in accordance with the invention. As shown previously in FIGS. 1-4, the regulating mechanism 6 consists, at one end, of a handle or similar, which at the other end is equipped with a catch lever that engages a toothed means 8 on the underside of the shopping basket. The shopping basket 4 is rotatably connected to the fastening device by means of an axle or a hinge 7. The regulating mechanism 6 is spring loaded, so that by pulling the handle to the right in FIG. 6, the catch lever will disengage the toothed means 8 and the shopping basket 4 may be rotated to the desired position about the axle or hinge 7. When the regulating mechanism 6 is released, the spring loading will cause the regulating mechanism to move to the left in FIG. 5, and the catch lever engages the toothed means 8. FIGS. 6 and 7 show how the angle of the shopping basket 4 may be adjusted by means of the regulating mechanism 6. FIG. 6 shows the shopping basket 4 in a first position, while FIG. 7 shows the shopping basket 4 in a second position.

In the embodiment shown in FIGS. 1-4, a shopping basket 4 or similar is attached to the fastening device. Seen from the side, the shopping basket 4 has a generally guttiform cross section. The purpose of this will be explained in greater detail later.

In FIGS. 8 to 11, the embodiment of the fastening device is shown attached to the handle of a pram. FIG. 8 shows only an embodiment of the fastening device attached to the handle, while FIGS. 9 to 11 also show the shopping basket 4 mounted. The fastening device is mounted on the handle 5 of the pram in a manner such that the cross bar 3 lies on the top of the handle 5, while the hook-shaped organ 2 grips the handle 5. The regulating means 6 has been adjusted to secure the fastening device to the handle 5.

In FIGS. 6 to 8, the fastening device with the mounted shopping basket 4 is shown attached to a pram. The shopping basket 4 is shaped so as to allow a person pushing the pram to see the child at all times. Seen from the side, the shopping basket 4 has a general drop shape. This shape is also expedient with regards to the centre of gravity. As a result of the shape of the shopping basket 4 and the positioning of this on the pram, the centre of gravity of the shopping basket 4 and the items placed in it will end up between the two pairs of wheels of the pram, thus eliminating the risk of the pram tipping backwards when the shopping basket is full.

The fastening device in accordance with the invention may also be used for attaching children's seats to shopping trolleys. As mentioned previously, most major shops have special shopping trolleys equipped with rigidly mounted children's seats. This is a great disadvantage, as a number of shopping trolleys will be taken up by being reserved for customers with children. Instead of having a number of shopping trolleys with rigidly mounted children's seats, it will now be possible to mount the fastening device in accordance with the invention to a child's seat, which may then be attached to a shopping trolley in a detachable manner. The shop would then only need a small number of children's seat mounted on a fastening device, and the customers may place the seat on the shopping trolley themselves.

1. A fastening device for detachable mounting of a shopping basket or child's seat on a pram or a shopping trolley, characterised in that the fastening device includes a cross bar (3) to be positioned across the generally parallel parts of a handle (5) of a pram or a shopping trolley, along with a hook-shaped organ (2) connected to the cross bar (3) for placement across that part of the handle (5) which connects the generally parallel parts of the handle (5).

2. A fastening device in accordance with claim 1 including a shopping basket (4) or a child's seat, characterised in that the device comprises a regulating means (6) for adjusting the angle of the shopping basket (4) or child's seat relative to the fastening device.

3. A fastening device in accordance with claims 1-2, characterised in that one end of the regulating means (6) is equipped with a handle or a lever, and the other end is equipped with a catch lever that engages a complementary shaped toothed means (8) on the underside of the shopping basket (4) or the child's seat, that the shopping basket (4) or child's seat is rotatably connected to the fastening device by means of a hinge or an axle (7), and that the regulating means is spring loaded to engagement with the toothed means (8).

4. A fastening device in accordance with one or more of the preceding claims, characterised in that the shopping basket (4) has a generally guttiform cross section.
